(19) United States
(12) Patent Application Publication
(10) Pub. No.: US 2023/0199917 A1
(43) Pub. Date: Jun. 22, 2023

(54) INFRARED HEATER

(71) Applicant: Valueneers GmbH, Kirchgellersen (DE)

(72) Inventor: Thorsten Jürries, Hastings (GB)

(21) Appl. No.: 18/075,132

(22) Filed: Dec. 5, 2022

(30) Foreign Application Priority Data
Dec. 17, 2021 (DE) 10 2021 133 587.6

(51) Int. Cl. H05B 3/26

(52) U.S. Cl. CPC H05B 3/262; H05B 2203/003; H05B 2203/032

(57) ABSTRACT

An infrared heater having a reflector body that includes a first and a second planar reflection section for arranging one infrared radiator in each case and a reflector opening opposite the reflection sections. In order to provide an infrared heater that allows for controlled emission of heat, the reflection sections extend in planes with respect to a first longitudinal axis, which planes are oriented so as to be inclined in relation to one another and which each extend at different inclinations in relation to an opening plane that is oriented in parallel with the first longitudinal axis and that is spanned by the reflector opening.

### CROSS-REFERENCE TO RELATED APPLICATION

This application claims the benefit of Germany Patent Application No. 10 2021 133 587.6, filed Dec. 17, 2021, which is incorporated herein by reference in its entirety.

### FIELD OF THE INVENTION

The invention relates to an infrared heater having a reflector body which comprises
a first and a second planar reflection section for arranging one infrared radiator in each case and
a reflector opening opposite the reflection sections.

### BACKGROUND OF THE INVENTION

Infrared heaters of the kind mentioned above are known in a variety of designs from the prior art and are used to heat living spaces, for example, by means of thermal radiation.

Infrared heaters having reflector bodies which typically comprise two reflection sections designed to receive infrared radiators are also known from the prior art. In this case, the reflection sections are designed to reflect infrared radiation from the respectively assigned infrared radiators and to direct said radiation in a desired direction. This is especially important for emitting the infrared radiation in a directed manner in order to thereby achieve reliable heating of selected areas, for which purpose the infrared heater comprises a reflector opening opposite the reflection sections.

However, the known infrared heaters are only insufficiently suitable for emitting infrared radiation in a predefined spatial direction, and therefore living spaces, for example, or more specifically selected areas can only be heated in a insufficient manner, in particular in a not uniform manner, or alternatively multiple infrared heaters are required to heat a living space in the desired manner.

### SUMMARY OF THE INVENTION

Proceeding from this, the object of the invention is to provide an infrared heater which allows for emission of heat that is as controlled as possible.

The present invention achieves this object by means of an infrared heater having the features disclosed herein. Advantageous developments of the infrared heater are given herein.

The infrared heater according to the invention is characterized in that it comprises reflection sections which extend in planes, which planes are oriented so as to be inclined in relation to one another with respect to a first longitudinal axis and which each extend at different inclinations in relation to an opening plane that is oriented in parallel with the first longitudinal axis and that is spanned by the reflector opening.

The reflector opening comprises different cross sections depending on the geometric design of the reflector body. In the case of a hemispherical reflector body, for example, the reflector opening may be designed to be circular, whereas in the case of a cuboid reflector body the reflector opening may be designed to be rectangular. An opening plane that is arranged at a distance from the reflection sections and that is aligned in parallel with the first longitudinal axis is spanned by the reflector opening.

According to the invention, the first and second reflection section extend in a first and second plane, respectively, wherein said planes are inclined about the first longitudinal axis in such a way that the two planes are aligned so as to be inclined with respect to one another. Within the context of the invention, this should be understood to mean an orientation of the first and second plane in which they enclose an angle of 120° to 178° opposite the opening plane. The angle between the first plane and the opening plane thus deviates from the angle between the second plane and the opening plane. Therefore, the first plane and second plane are inclined at different angles to the opening plane.

Infrared radiators are arranged in each case on the first and second reflection section. The infrared radiators are therefore also oriented at different inclinations on account of the design of the reflection sections with different inclinations. The infrared radiation of the infrared radiators is partly emitted directly through the reflector opening and partly reflected by means of reflection on the reflection sections through the reflector opening. The divergence of the infrared radiation reflected by the reflection sections is determined by means of the angles between the first and second plane. The infrared radiation can therefore be directed in a targeted manner.

The infrared heater according to the invention therefore allows for targeted emission of the infrared radiation on account of the differently inclined reflection sections. On account of the design with different angles, a living space, for example, or rather particular regions can be heated precisely with thermal radiation.

Within the scope of the design according to the invention, the number and specific orientation of the reflection sections are freely choosable. However, according to a preferred embodiment of the invention, at least a third and a fourth reflection section are provided, which are each inclined with respect to the opening plane relative to a second longitudinal axis that is perpendicular to the first longitudinal axis. On account of the right-angled orientation of the second longitudinal axis with respect to the first longitudinal axis, the third and fourth reflection section can thus deflect infrared radiation in another direction. As a result, an emission angle for heating can be determined in a particularly exact manner. Within the context of the invention, the emission angle denotes the angle in which the infrared radiation is emitted from the opening plane.

The angle formed by the third and fourth reflection section to the opening plane with respect to the second longitudinal axis is, in principle, freely choosable. For example, the third and fourth reflection section may be oriented at different angles to the opening plane with respect to the second longitudinal axis. However, according to an advantageous embodiment of the invention, the third and fourth reflection section are inclined at symmetrical angles to the opening plane with respect to the second longitudinal axis. Symmetrical angles should be understood to mean angles of the same size. This arrangement makes it possible to achieve a uniform emission of heat with respect to the second longitudinal axis.

The infrared heater may, for example, be independently designed only as a reflector body having the required attachments, such as the infrared radiators and the required supply lines. According to a preferred embodiment of the invention, it is provided that the reflector body is arranged in a housing comprising a housing opening and a housing rear wall. The reflector body may be arranged in the housing in such a way that the reflector opening is arranged in the direction of the housing opening. The housing rear wall may, for example, be designed such that it has the shape of the reflector body in order to ensure a compact design. Furthermore, the housing rear wall may comprise cut-outs for feeding through cables. The housing may, for example, be made of heat-resistant plastics material or metal. Particularly preferably, the housing may be made of a thermally conductive material in order to prevent the infrared heater from overheating. The housing rear wall may comprise means for fastening the housing to a wall.

According to an advantageous embodiment of the invention, it is provided that the reflector body is spaced apart from the housing rear wall. As a result, a cavity can be spanned between the reflector body and the housing rear wall. Said cavity may, for example, be filled with insulating material. Furthermore, cables of a power supply or control components for controlling the infrared radiators may also be arranged in the cavity.

According to a preferred embodiment of the invention, a front panel is provided, which covers the reflector opening and the housing opening of the advantageously provided housing. The front panel may surround the housing at least in sections. Since the infrared radiators may also emit a small proportion of visible light, a front panel on the housing opening makes it possible to protect the user from glare. Furthermore, a front panel provides good protection for the reflector body and the infrared radiators against external influences as well as against touching by a user, which could lead to injuries.

The way in which the front panel is, in principle, freely selectable. For example, the front panel may be designed as a continuous plastics body that is transparent to infrared radiation. However, according to a particularly advantageous embodiment of the invention, the front panel comprises at least one opening. On the one hand, said opening may be provided for preventing the infrared radiators from overheating. On the other hand, the opening ensures that the infrared rays emitted by the infrared radiator can exit the housing in an unhindered manner, which allows for rapid heating of the intended regions. The opening may, for example, also be filled with a material that is infrared-transmissive. Particularly preferably, the front panel may comprise openings in the form of perforations. Perforations may, for example, be designed in the form of small holes or slots that are spaced apart from one another.

In order to increase the efficiency of the reflection section, a suitable coating, for example, may be applied onto the reflection section. According to a preferred embodiment of the invention, at least one reflection section, preferably all reflection sections, comprise a profiled reflection surface at least in sections. The reflection surface may, for example, be designed so as to be grooved or corrugated. On account of this design of the reflection surface, the divergence of the infrared radiation and the emission angle can be increased.

The number of components for manufacturing the reflector body is arbitrarily choosable. For example, the reflector body may be formed of multiple pieces. According to an advantageous embodiment of the invention, the reflector body is formed in one piece, in particular as a sheet metal body. A one-piece reflector body has the advantage that the individual components do not have to be assembled, and therefore the reflector body can be manufactured in few work steps, which leads to a speeding up of the production. The reflector body may, for example, be made of plastics material, wherein metal inserts are preferably formed in sections in order to reflect the infrared radiation. In order for plastics material to be able to reflect infrared radiation, the reflector body made of plastics material may be coated, for example.

Particularly preferably, the reflector body may be made of a metal that is easy to work, for example sheet metal. In order to form planar reflection sections, the sheet metal may, for example, be deep-drawn or formed from a planar sheet metal body by means of suitable folding processes. For this purpose, the sheet metal body for manufacturing the reflector body may be punched from a planar metal sheet and provided with folds and incisions in order to facilitate the bending processes for manufacturing the reflector body. Furthermore, the reflector body may comprise a device for being fastened to a wall.

A temperature sensor may be provided for monitoring the operating temperature of the infrared heater. For example, the temperature sensor may be arranged in the living space to be heated. Alternatively or additionally, the temperature sensor may be provided in the housing at a distance from the reflector body. According to a particularly advantageous embodiment of the invention, at least one temperature sensor is arranged on the reflector body. The temperature sensor can therefore monitor the operating temperature of the infrared heater in order to prevent overheating. Particularly preferably, two temperature sensors may be arranged as overheating protection. A control unit that is connected to the temperature sensor may be provided for monitoring and control purposes. Particularly preferably, said control unit comprises a module that enables wireless control.

### BRIEF DESCRIPTION OF THE DRAWINGS

Exemplary embodiments of the invention are set out in more detail below with reference to the drawings. They are not intended to limit the invention, but rather merely to explain it. In the drawings:

FIG. 1 is a front view of an infrared heater having four infrared heaters;

FIG. 2 is a cross section of the infrared heater shown in FIG. 1, along a second longitudinal axis.

FIG. 3 is a front view of a sheet metal body;

FIG. 4 is a perspective view of a housing;

FIG. 5 is a front view of a front panel with perforations.

### DETAILED DESCRIPTION OF EMBODIMENTS

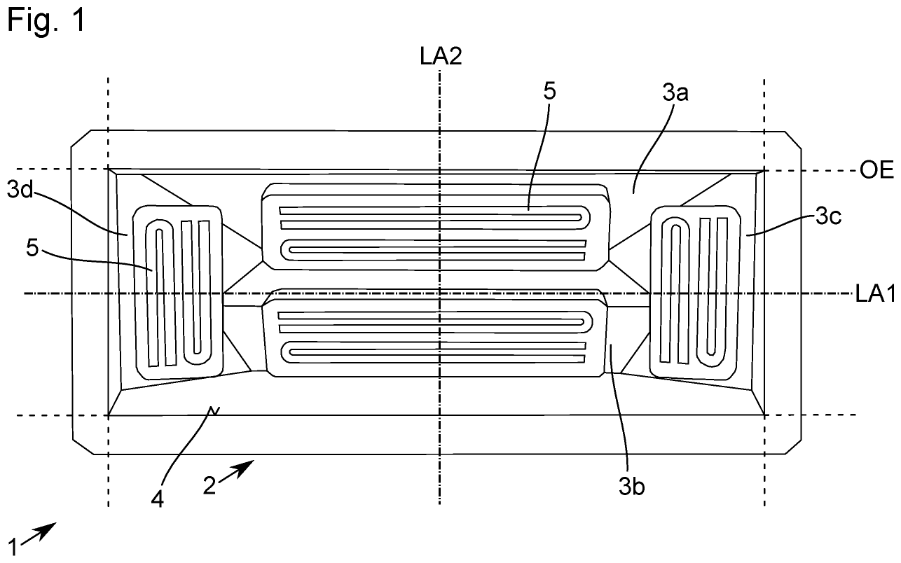

An embodiment of an infrared heater 1 shown in a front view in FIG. 1 comprises a reflector body 2 having four planar reflection sections 3a, 3b, 3c, 3d, wherein four infrared radiators 5 are arranged at the four reflection sections 3a, 3b, 3c, 3d. The reflector body 2 is formed in one piece from a metal sheet. The reflection sections 3a, 3b, 3c, 3d have a profiled reflection surface (not shown here). Opposite the reflection sections 3a, 3b, 3c, 3d, the reflector body 2 comprises a reflector opening 4, wherein the reflector opening 4 spans an opening plane OE.

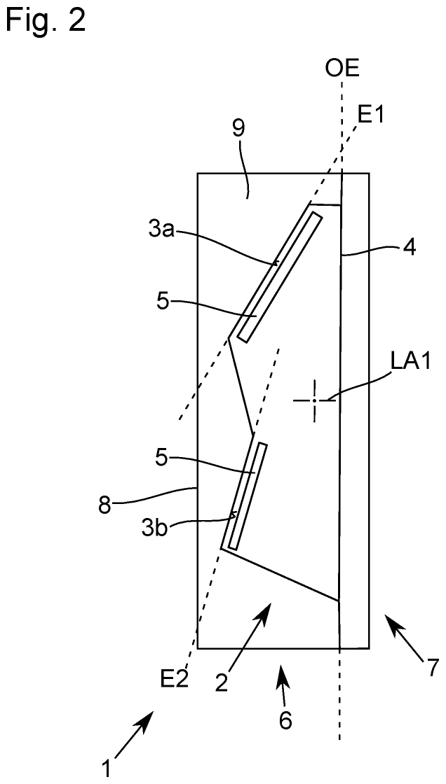

The first reflection section 3a extends in a first plane E1, whereas the second reflection section 3b extends in a second plane E2, and therefore said reflection sections extend so as to be inclined in relation to one another (cf. FIG. 2). The first reflection section 3a lying in the first plane E1 and the second reflection section 3b lying in the second plane E2 are inclined at different angles to a first longitudinal axis LA1 with respect to the opening plane OE, wherein the first reflection section 3a is inclined at an angle of 150° to the opening plane and the second reflection section 3b is inclined at an angle of 164° to the opening plane. Therefore, the infrared radiators 5 arranged on the first and second reflection section 3a, 3b are also arranged so as to be inclined accordingly.

The third and fourth reflection section 3c, 3d are inclined at symmetrical angles to a second longitudinal axis LA2 that is perpendicular to the first longitudinal axis LA1 with respect to the opening plane OE (cf. FIG. 1).

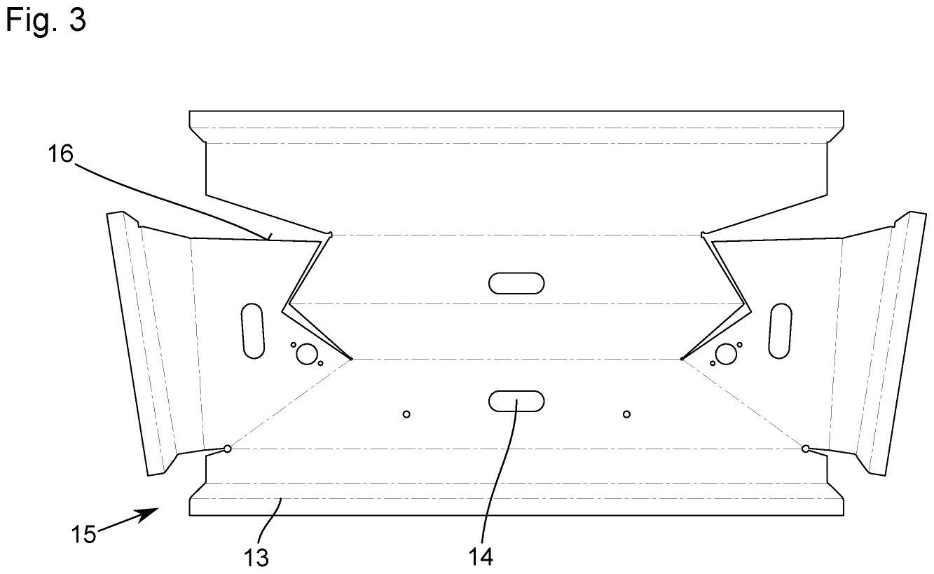

The reflector body 2 is formed from a sheet metal body 15 punched from a planar metal sheet (cf. FIG. 3). Folds 13 and incisions 16 are provided in the planar sheet metal body 15 in order to manufacture the shell-shaped reflector body 2 by means of bends along the folds 13. Furthermore, the reflector body 2 comprises cable openings 14.

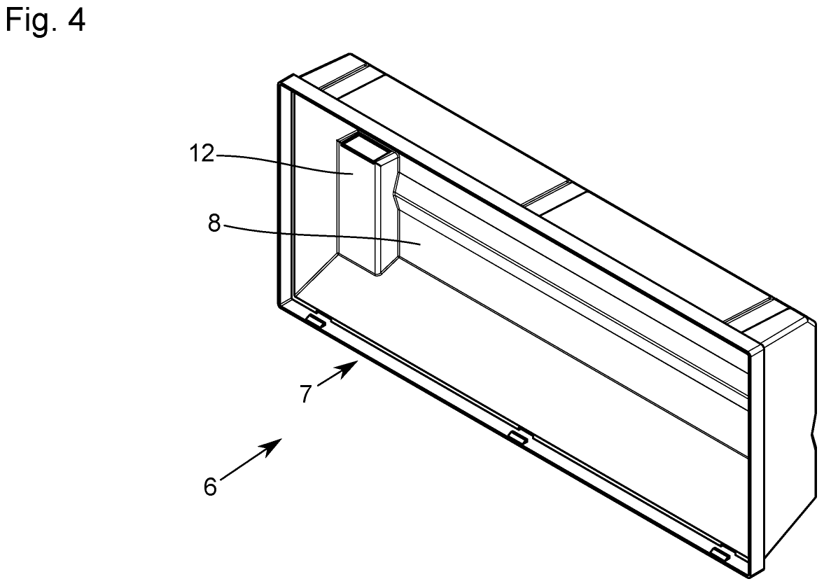

In order to protect the reflector body 2 against external influences, the reflector body 2 is arranged in a housing 6 (cf. FIG. 2 and FIG. 4). The housing 6 comprises a housing opening 7 and a housing rear wall 8. The reflector body 2 is arranged at a distance from the housing rear wall 8, as a result of which a cavity 9 is formed between them. Insulating material (not shown here) for insulation and a cable channel 12 are accommodated in the cavity 9.

Furthermore, two temperature sensors are arranged on the reflector body 2 in order to monitor the operating temperature of the infrared heater 1 (not shown here).

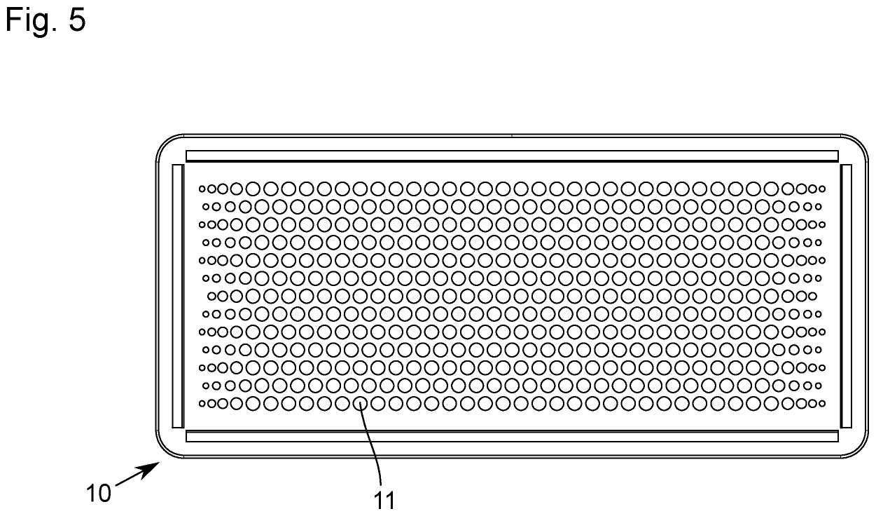

In order to protect the reflector body 2 against external influences, a front panel 10 is arranged on the housing opening 7 of the housing 6 to cover the reflector opening 4 (cf. FIG. 5). The front panel 10 is made of metal and comprises openings in the form of perforations 11 in order to prevent the infrared heater 1 from overheating.

1. An infrared heater having a reflector body which comprises
a first and a second planar reflection section for arranging an infrared radiator in each case and
a reflector opening lying opposite the reflection sections,
wherein
the reflection sections extend in planes, which planes are oriented so as to be inclined in relation to one another with respect to a first longitudinal axis and which each extend at different inclinations in relation to an opening plane that is oriented in parallel with the first longitudinal axis and that is spanned by the reflector opening.

2. The infrared heater according to claim 1, characterized by at least one third and fourth reflection section, which are each inclined with respect to a second longitudinal axis that is perpendicular to the first longitudinal axis in relation to the opening plane.

3. The infrared heater according to claim 2, wherein the third and fourth reflection section are inclined at symmetrical angles to the opening plane with respect to the second longitudinal axis.

4. The infrared heater according to claim 1, wherein the reflector body is arranged in a housing comprising a housing opening and a housing rear wall.

5. The infrared heater according to claim 4, wherein the reflector body is spaced apart from the housing rear wall.

6. The infrared heater according to claim 4, characterized by a front panel which covers the reflector opening and the housing opening of the housing.

7. The infrared heater according to claim 6, wherein the front panel comprises at least one opening.

8. The infrared heater according to claim 1, wherein at least one reflection section, or all reflection sections, comprise a profiled reflection surface at least in sections.

9. The infrared heater according to claim 1, wherein the reflector body is formed of one piece as a sheet metal body.

10. The infrared heater according to claim 1, wherein at least one temperature sensor is arranged at the reflector body.
